(19) United States
(12) Patent Application Publication
(10) Pub. No.: US 2006/0039315 A1
(43) Pub. Date: Feb. 23, 2006

(54) Macro diversity schemes for shared dedicated control channel in broadcast multicast services

(76) Inventors: Hao Bi, Lake Zurich, IL (US); Zhijun Cai, N. Richland Hills, TX (US); Sean M. McBeath, Keller, TX (US); John D. Reed, Arlington, TX (US)

Correspondence Address: MOTOROLA INC, 600 NORTH US HIGHWAY 45, ROOM AS437, LIBERTYVILLE, IL, 60048-5343, US

(21) Appl. No.: 10/922,505

(22) Filed: Aug. 20, 2004

(51) Int. Cl. H04Q 7/00

(52) U.S. Cl. 370/328

(57) ABSTRACT

A method in a wireless communication station including receiving frames (310), determining the intended recipient of the frames received (312), buffering frames (314) if required, obtaining information specifying how to decode signals received by the wireless communication station (316), combining frames (318), and decoding the combined frames as specified (320).

### FIELD OF THE DISCLOSURE

The present disclosure relates generally to wireless communications, and more particularly to using different schemes, for example, selective coding, maximum ratio combining, etc., for decoding signals received at wireless communication stations, and also to methods in the network side for selecting decoding schemes for mobile stations and notifying the mobiles stations accordingly.

### BACKGROUND OF THE DISCLOSURE

In the Broadcast Multicast Services (BCMCS) of cdma2000, Release D, the Forward Dedicated Control Channel (F-DCCH) may be shared by multiple mobile stations operating in Time Division Multiplex (TDM) mode. Particularly, in some applications multiple mobile stations monitor the same F-DCCH, wherein different frames of the F-DCCH transmission are addressed to different mobile stations using corresponding long code masks. Push-to-Talk group calling is an exemplary application where a forward fundamental channel (F-FCH) broadcasts voice to multiple mobile stations and a shared F-DCCH carries signaling to individual mobile stations. In this exemplary application, among others, while the same content is carried on the F-FCH to a group of mobile stations, signaling carried on the F-DCCH, such as soft handoff messaging, varies among the different mobile stations. Each mobile station also has a different active set for the shared F-DCCH.

Transmission to a mobile station on a shared F-DCCH generally prevents the use of the shared F-DCCH resource for other mobile stations. For example, if a mobile station is in soft handoff with cell/sectors 1, 2 and 3, and another mobile station is in soft handoff with cell/sectors 3, 4 and 5, transmissions on the F-DCCH must be coordinated by the network to prevent interfering transmissions in cell/sector 3. Handoff situations aside, when a mobile station communicates with cell/sector 1, its transmission schedule on the F-DCCH of cell/sector 1 affects the transmission schedule of other mobile stations on the shared F-DCCH of cell/sectors 1, 2 and 3 and in turn impacts the transmission schedule of mobile stations on the shared F-DCCH of cell/sectors 3, 4 and 5.

In conventional maximum ratio combining (MRC), signaling for a particular mobile station is sent at the same time from all members of the active set. To enable MRC on shared F-DCCH across a network, all mobile stations sharing the F-DCCH must be coordinated, for example, by a central scheduler. In a network having many of cells/sectors each having dozens of users, however, the coordination and management load on the central scheduler becomes unmanageable.

The various aspects, features and advantages of the disclosure will become more fully apparent to those having ordinary skill in the art upon careful consideration of the following Detailed Description thereof with the accompanying drawings described below.

### BRIEF DESCRIPTION OF THE DRAWINGS

FIG. 1 is an exemplary wireless communication system.

FIG. 2 is an exemplary base transceiver station.

FIG. 3 is a flow chart for an exemplary process in a wireless communication device.

FIG. 4 is an exemplary scheme for encoding recipient identification on a frame structure.

FIG. 5 is an exemplary scheme for controlling how a mobile station decodes information.

### DETAILED DESCRIPTION

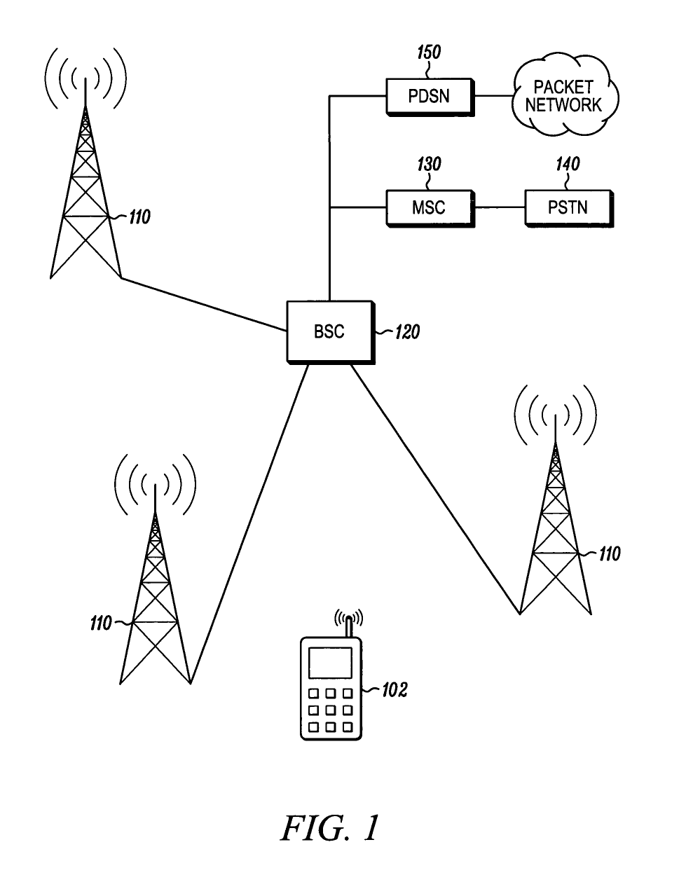

In FIG. 1, the exemplary wireless communication system 100 comprises one or more base transceiver stations (BTS) 110 communicably coupled to a corresponding base station controller (BSC) 120. The multiple base transceivers stations communicate with wireless terminals, for example, mobile station 102, in corresponding cellular areas. More generally there are multiple base station controllers controlling a corresponding bevy of base transceiver stations. The one or more base station controllers are communicably coupled to a corresponding mobile switching center (MSC) 130, which is communicably coupled to a public switched telephone network (PSTN) 140. In the exemplary system, the one or more base station controllers are also communicably coupled to a corresponding packet data serving node (PDSN) 150, which is communicably coupled to a packet network.

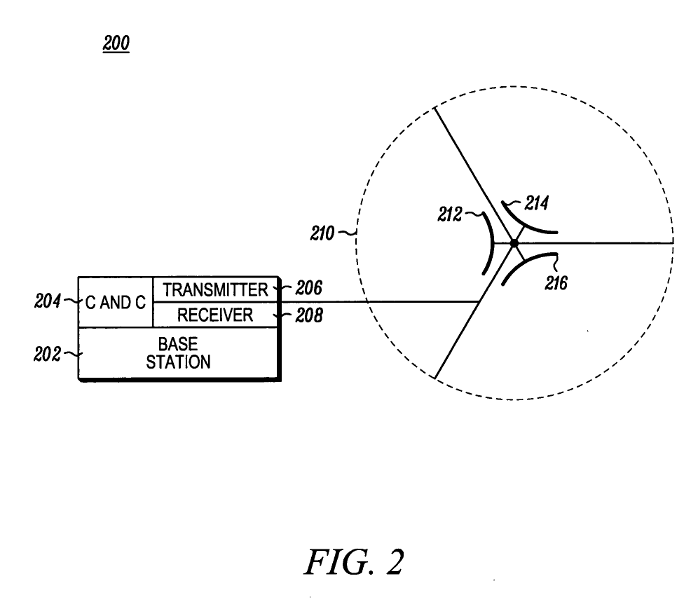

FIG. 2 is a detailed illustration of an exemplary base transceiver station 200 for providing wireless communication coverage to users within communication range or cellular coverage area thereof. The exemplary base transceiver station includes a communication and control portion 204, which communicate with the MSC and PDSN. The exemplary base transceiver station also includes receivers 208 and transmitters 206, which are both coupled to an antenna system 210. The exemplary antenna system comprises three sectors 212, 214 and 216, each of which provides communication coverage over a nominal range of 120 degrees. In some wireless communication protocols, the base station provides different signals to each antenna sector. In the cdma2000 protocol, for example, a wireless communication device may be in softer handoff between different sectors of the same base transceiver station. Other antenna systems may have other configurations, for example, more or less sectors. Alternatively, the antenna system could be an omni-directional transmitter or an array type structure, among other configurations.

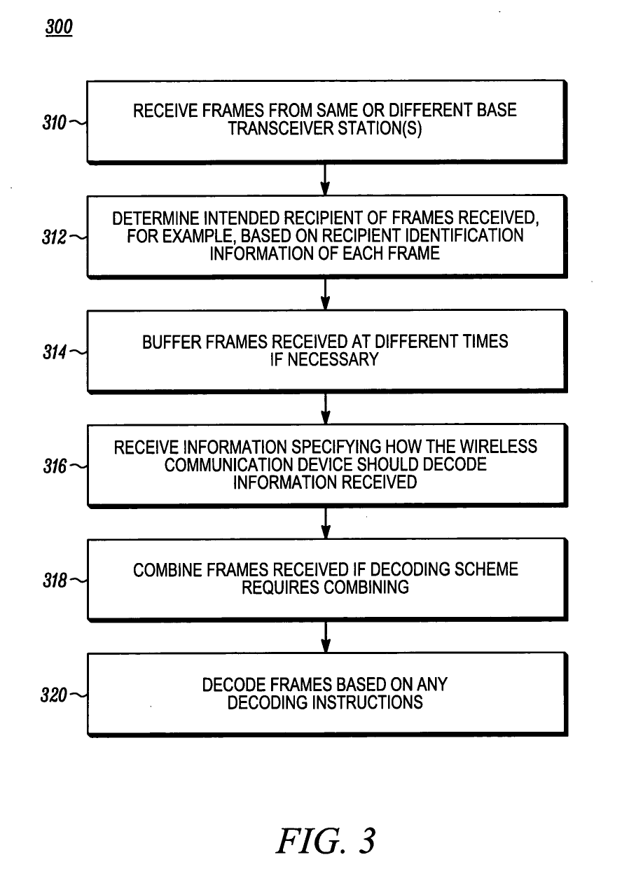

In the exemplary process 300 of FIG. 3, at logical block 310, the wireless communication device, for example, the mobile station 102 in FIG. 1, receives a plurality of frames containing data and/or other information. The frames originate generally from the same or from different base transceiver stations, for example, from one of the base transceiver stations 110 in the cellular communication network of FIG. 1.

In FIG. 3, at block 312, the wireless communication station determines whether the plurality of received frames are addressed to it. In one embodiment, the base transceiver station transmits frames including address information that identifies an intended recipient. In the exemplary cdma2000 application, for example, the base transceiver transmits code according to mobile station identification and frame sequence numbering information at locations known to mobile stations in modulated symbols. The inclusion of identification information in the frames enables maximum ratio combining (MRC) in environments where frame signaling is not synchronized as discussed further below.

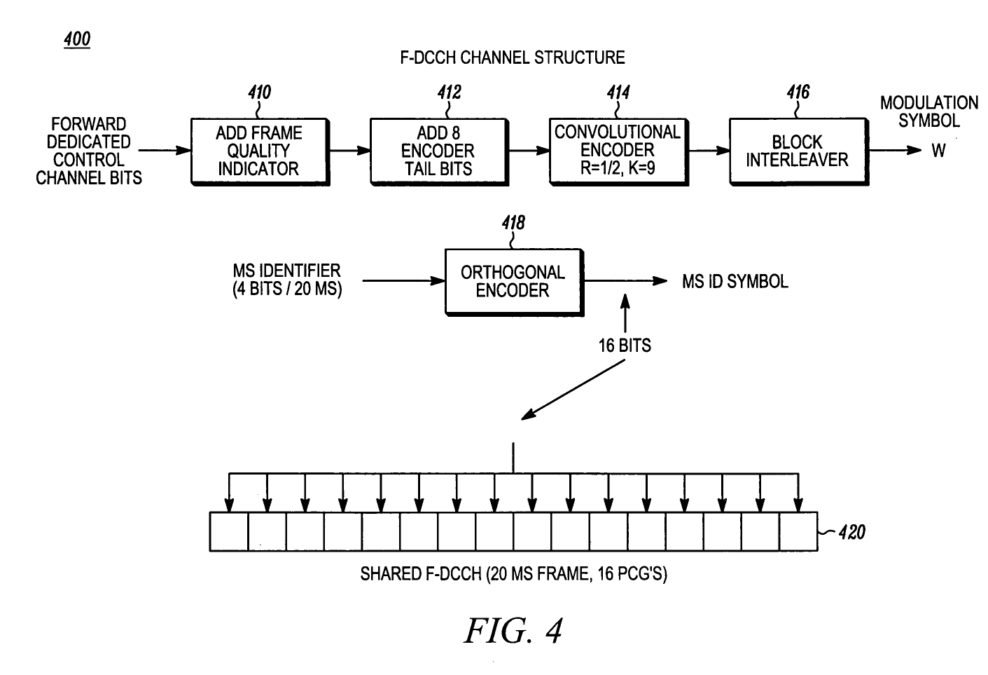

FIG. 4 illustrates a process for encoding a mobile station identifier, or an address, on a Forward Dedicated Control Channel (F-DCCH) frame, which may be received by multiple mobile stations. The process occurs at the network infrastructure, for example, at a base transceiver station. At block 410, a frame quality indicator is added to the control channel bits. At block 412, encoder tail bits are added before convolutional encoder processing occurs at block 414. Block 416 interleaves blocks.

In one embodiment, error-correcting coding is used to increase the reliable reception of the identification code. One way is to use a block coding scheme wherein a multi-bit identification number is mapped into a length 16 Walsh code. Each mobile station is assigned a different identification number, which is known by the mobile station. The resultant Walsh code is then transmitted onto the F-DCCH at pseudo-randomized location according to the frame number sequence. At each mobile station, the Walsh code is extracted from the received data using the known pseudo-randomized location and is correlated against the Walsh code corresponding to mobile stations identification code, with appropriate threshold, to detect if this frame on the F-DCCH is intended for the mobile station.

In the exemplary embodiment of FIG. 4, four identifier bits are encoded with an orthogonal encoder 418 to create a 16-bit identification symbol. The bits of the identification symbol are transmitted with the modulation symbols at locations determined by a pre-defined rule. In the exemplary embodiment, each bit of the 16-bit identification symbol is transmitted in a corresponding power control group. In FIG. 4, the 16 power control group symbols constitute a 20 ms frame 420 on the Forward Dedicated Control Channel (F-DCCH). In the exemplary embodiment where the bits of a multi-bit identification symbol are transmitted with modulation symbols, the recipient wireless communication device correlates a reference code with the received code to determine the intended recipient of the frame.

In one embodiment, different wireless communication stations are signaled using the forward dedicated control channel (F-DCCH) in a shared mode. The wireless communication station identification information is transmitted on a forward dedicated control channel in locations determined by a pre-defined rule.

The encoding of frame with unique identifier information is discussed more fully in co-pending U.S. Publication No. ______ corresponding to U.S. application Ser. No. 10/683,761, entitled “apparatus and Method for Distinguishing a Frame on a Channel Shared By Multi Users”, the contents of which are incorporated herein by reference.

In FIG. 3, at block 314, in some embodiments, the wireless communication station buffers some of the frame received. Frames sent at different times from the same or different base transceiver stations may be buffered at the wireless communication device, for example, where different frames addressed to the wireless communication station are received at different times.

In FIG. 3, at block 316, the wireless communication device or station receives information specifying how the device should decode information received by the wireless communication device. In one embodiment, the wireless communication device receives information specifying the use of maximum ratio combining (MRC) to decode signals received by the wireless communication station. In another embodiment, the wireless communication device receives information specifying whether to use selective combining (SC) or maximum ratio combining (MRC) to decode signals received by the wireless communication station. In other embodiment, the notification may indicate or instruct the use of some other decoding scheme. In FIG. 3, the decoding notification or instructions may be received prior to or sometime during or after the reception of frame information.

In one embodiment, the wireless communication device receives the information specifying how to decode signals in a channel assignment message. In other embodiments, the decoding instructions or information may be received in some other message. In some embodiments, the wireless communication device has a default or preferred decoding process in the absence of instructions from the network. The notification, for example, the setting of a flag, in the message may indicate that the mobile station decode using a pre-specified alternative decoding scheme, as discussed further below.

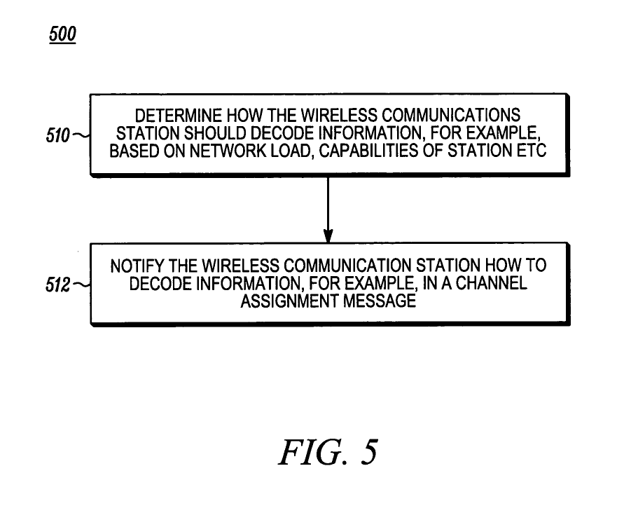

FIG. 5 illustrates an exemplary process 500 occurring on the network infrastructure part of a wireless communication network, for example, in the base station controller 120 in the cellular network of FIG. 1. At block 510, the network determines how a wireless communication station should decode information received. In some embodiments, determining how the wireless communication station should decode information received is based on network load. For example, where the system load is moderate to high, in some networks, it may be more desirable to use selective combining (SC) rather than maximum ratio combining (MRC). Determining how the wireless communication station should decode information received may also be based on whether or not the wireless communication station is in soft handoff with sectors on different base stations. On some networks, it may be more desirable to use selective combining rather than other decoding schemes when the mobile station is in soft handoff with different cells. The capability of the wireless communication station, among other considerations, for example, the availability of local buffering resources, may be considered when determining how the wireless communication station should decode information.

In FIG. 5, at block 512, the network communicates with or notifies the wireless communication station how to decode information received by the wireless communication station. In one embodiment, the network send the notification by setting a flag, for example, setting a bit, in a layer 3 signaling message, for example, a channel assignment message. In other embodiments, decoding instruction information may be encoded using multiple bits.

More generally, the process of FIG. 5 is performed for multiple wireless communication devices or stations. In some applications, some mobile stations may be instructed to use one decoding scheme and other mobile stations in the same cell or under control of the same base station controller may be instructed to use a different decoding scheme. Also, a particular mobile station may be instructed to use one decoding scheme at one time and then at a later time be instructed to use a different decoding scheme.

In FIG. 3, at block 318, the wireless communication device combines the frames intended for receipt by the wireless communication device if the decoding scheme requires combining. In embodiments where the wireless communications device uses maximum ratio combining (MRC), for example, the frames addressed to the wireless communication device are combined before decoding, as indicated at block 318. In other embodiments, for example, where selective combining (SC) is used, the frames are decoded independently without combining.

At block 320, the wireless communication device decodes the frames, and in some embodiments the decoding is based on decoding instructions received by the wireless communication device from the network as discussed above.

While the present disclosure and what are presently considered to be the best modes thereof have been described in a manner establishing possession by the inventors and enabling those of ordinary skill in the art to make and use the same, it will be understood and appreciated that there are many equivalents to the exemplary embodiments disclosed herein and that modifications and variations may be made thereto without departing from the scope and spirit of the inventions, which are to be limited not by the exemplary embodiments but by the appended claims.

What is claimed is:

1. A method in a wireless communication station, the method comprising:
receiving a plurality of frames, the plurality of frames having identification information;
combining frames having identification information corresponding to the wireless communication station before decoding.

2. The method of claim 1,
receiving the frames having identification information corresponding to the wireless communication station at different times,
buffering at least some of the frames received at different times before combining frames having identification information corresponding to the wireless communication station.

3. The method of claim 1,
determining whether any of the plurality of frames have identification information corresponding to the wireless communication station,
combining only frames having identification information corresponding to the wireless communication station.

4. The method of claim 3,
determining whether any of the plurality of frames have identification information corresponding to the wireless communication station by correlating a reference code with a code transmitted at pseudo-randomized locations according to frame sequence numbering information.

5. The method of claim 1, receiving information specifying that a mobile station identification is transmitted with frames.

6. The method of claim 5, receiving information specifying how to decode signals received by the wireless communication station in a channel assignment message.

7. The method of claim 5, receiving information specifying whether to use selective combining or maximum ratio combining to decode signals received by the wireless communication station.

8. The method of claim 1,
receiving the frames having identification information corresponding to the wireless communication station at different times,
decoding the combined frames after combining.

9. The method of claim 1, using conventional maximum ratio combining on combined frames received at different times.

10. A method in a wireless communication station, the method comprising:
receiving information specifying use of maximum ratio combining to decode signals received by the wireless communication station;
receiving a plurality of frames having identification information;
combining frames having identification information corresponding to the wireless communication station;
decoding the combined frames as specified.

11. The method of claim 10,
receiving the frames having identification information corresponding to the wireless communication station at different times.

12. The method of claim 10,
receiving the plurality of frames having identification information corresponding to the wireless communication station from different base transceiver stations.

13. The method of claim 10,
receiving the plurality of frames having identification information corresponding to the wireless communication station from different sectors of a common base transceiver station.

14. A method in a mobile wireless communication station, the method comprising:
receiving instruction specifying how to decode information received by the mobile wireless communication station;
decoding information received by the mobile wireless communication station as specified in the instructions.

15. The method of claim 14,
receiving a plurality of frames having identification information;
combining frames having identification information corresponding to the mobile wireless communication station,
decoding the combined frames as specified in the instructions.

16. A method in a wireless communication station, the method comprising:
decoding information using a first decoding scheme;
receiving a message specifying the use of a second decoding scheme;
decoding information using the second decoding schemes after receiving the message,
the second decoding scheme different than the first decoding scheme.

17. The method of claim 16,
receiving the message specifying the use of one of selective combining and maximum ratio combining to decode signals received by the wireless communication station.

18. A method in a wireless communication network infrastructure, the method comprising:
determining how a wireless communication station should decode information received;
notifying the wireless communication station how to decode information received by the wireless communication station.

19. The method of claim 18,
determining how a wireless communication station should decode information received includes determining whether the wireless communication station should use selective combining or maximum ratio combining to decode signals received by the wireless communication station.

20. The method of claim 18,
determining how a plurality of wireless communication stations should decode information received;
notifying at least some of the plurality of wireless communication stations to decode information received using a first decoding scheme; and
notifying at least some other of the plurality of wireless communication stations to decode information received using a second decoding scheme different than the first decoding scheme.

21. The method of claim 18,
determining how the wireless communication station should decode information received based on network load.

22. The method of claim 18,
determining how the wireless communication station should decode information received based on whether the wireless communication station is in soft handoff with sectors on different base stations.

23. The method of claim 18,
determining how the wireless communication station should decode information received based on a capability of the wireless communication station.

24. The method of claim 18,
signaling different wireless communication stations using a forward dedicated control channel in a shared mode.

25. The method of claim 24,
transmitting wireless communication station identification information on the forward dedicated control channel at pseudo-random locations.

26. A method in a wireless communication network infrastructure, the method comprising:
instructing a wireless communication station to decode information received using a first decoding scheme;
instructing the same wireless communication station to decode information received using a different decoding scheme after instructing the wireless communication station to decode information received using the first decoding scheme.
